(19) United States
(12) Patent Application Publication
(10) Pub. No.: US 2009/0074169 A1
(43) Pub. Date: Mar. 19, 2009

(54) Multi-Line Communication System

(75) Inventor: Prabhuram Mohan, San Jose, CA (US)

Correspondence Address: Jon P. Christensen;Welsh & Katz, Ltd., 120 S. Riverside Plaza, Chicago, IL, 60606, US

(73) Assignee: Aspect software Inc., Lombard, IL (US)

(21) Appl. No.: 11/857,574

(22) Filed: Sep. 19, 2007

(51) Int. Cl. H04M 3/56

(52) U.S. Cl. 379/202.01

(57) ABSTRACT

A method and apparatus are provided that allowing a user to simultaneously participate in two separate conversations. The method includes the steps of the user independently adjusting a volume of an audio signal for each of the two separate conversations, presenting the adjusted volume of the audio signals from the two separate conversations to the ears of the user, presenting a voice input from the user to a first of the two separate conversations and muting a voice input from the user to the second of the two separate conversations.

### FIELD OF THE INVENTION

The field of the invention relates to communication systems and more particularly to conference calls.

### BACKGROUND OF THE INVENTION

Teleconferences are well-known in the art. In a teleconference, a user typically calls into a conference center and enters a user ID number.

Upon entry of the user ID number, the conferencing center may join the participant to the conversation. As each participant joins the conversation, the conferencing center collects voice information from each participant, sums the voice information, normalizes the volume and distributes the collected, summed and normalized voice information to each participant.

In general, remote meetings (e.g., teleconferences) have become an increasingly important part of many people's daily activities. While a person is occupied with a teleconference, the person may receive calls from other people. The calls may be important and yet the person would not want to hang up or put the remote meeting on hold because they may be called upon to provide certain details or to speak of an issue, or because the person was waiting for some important details to be discussed. For example, if the person should interrupt the conference to talk to a caller on line 2, they have no way of knowing that something was asked of them during the conference on line 1 or their important or interesting details are just being discussed.

While voice mail provides a good alternative that avoids loss of information while the person is occupied by the teleconference, the time delay between the voice mail and response may be significant. By the time the person returns the call, the person who left the voice mail may have forgotten why he/she called. Alternatively, the passage of time may render the message irrelevant. Because of the importance of communications, a need exists for a way of allowing a person to handle multiple calls simultaneously.

### SUMMARY

A method and apparatus are provided that allows a user to simultaneously participate in two separate conversations. The method includes the steps of the user independently adjusting a volume of an audio signal for each of the two separate conversations, presenting the adjusted volume of the audio signals from the two separate conversations to the ears of the user, presenting a voice input from the user to a first of the two separate conversations and muting a voice input from the user to the second of the two separate conversations.

### BRIEF DESCRIPTION OF THE DRAWINGS

FIG. 1 is a block diagram of a conferencing system in accordance with an illustrated embodiment of the invention.

### DETAILED DESCRIPTION OF AN ILLUSTRATED EMBODIMENT

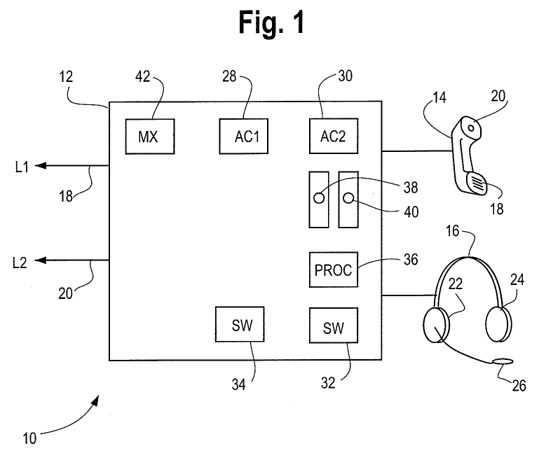

FIG. 1 depicts a call conferencing apparatus 10 shown generally in accordance with an illustrated embodiment of the invention that allows a user to simultaneously participate in two separate conversations. The call apparatus 10 may include a call controller 12 with at least two line inputs (call connections) 18, 20. While the call connections 18, 20 are show as separate inputs in FIG. 1 under a switched circuit format, it should be understood that call connection 18, 20 could be part of a single connection when voice information is exchanged under a packet format through the Internet. It should also be understood that the line inputs 18, 20 could be two antenna or a single antenna where voice information is exchanged under a cellular or WiFi format through a wireless device.

The controller 12 may also include at least one of two possible audio interfaces (i.e., audio transducers) 14, 16. The first audio interface 14 may be a conventional telephone handset 14 that includes a microphone 18 and a speaker 20. The second audio interface 16 may be a headset 16 with a left speaker 22 for a left ear of a user, a right speaker for a right ear of the user and a microphone 26.

The call conferencing apparatus 10 may be provided in any of a number of different formats. For example, the apparatus 10 may be provided as a set of software modules operating on a terminal of a user that provide the functionality described below. In this embodiment, control of the features of the call conferencing apparatus 10 may be provided through the use of soft keys appearing upon a display of the terminal.

Alternatively, the call conferencing apparatus 10 may be provided as a stand-alone unit. When provided as a stand-alone unit, the call conferencing apparatus 10 may be structured either as an Internet softphone or in the form of a multi-line telephone with the specific features and controls described below.

Under illustrated embodiments, the call conferencing apparatus 10 allows a user to simultaneously engage in two different conversations. As used herein, the term “conversation” refers to a user listening to at least one other person with the ability to respond to the other person at any time. Participation in two separate conversations means that only the user hears both conversations. Other participants of either of the two conversations only hear the audio content of their respective conversation and of the user, but only if he/she has selected that conversation.

As used herein, participation in two different conversations occurs simultaneously because the user listens to two different conversations simultaneously. The difference is that the user is only allowed to contribute audio input to one conversation at a time.

As used here, muting a voice input from a user to a conversation means blocking substantially any audio emanating from the user from reaching participants of one of the conversations.

Under a first illustrated embodiment of the invention, the call conferencing apparatus 10 may include a processor 36, two multiport switches 32, 34 and two call selection switches 28, 30. The first embodiment may be intended for use with a headset 16.

Each of the selection switches 28, 30 may be associated with a respective call connection 18, 20. If the user should activate the first selection switch 28 to make or receive a call, then the processor 36 may activate relay switch 34 to connect an inbound voice path from call connection 18 to both earphone speakers 22, 24 of the headset 16 and the microphone 26 to an outbound voice path of the call connection 18. If the user should activate the switch 28 a second time at the end of the call to hang up, then the processor 36 deactivates the relay switch 34 opening the connection between the earphones speakers 22, 24 and microphone 26 and the call connection 18.

The user is also provided with a pair of volume controls (e.g., slide switches) 38, 40. The first volume control 38 may control the audio volume of the voice signal to a first earphone (e.g., 22) and the second volume control 40 may control the audio volume sent to a second earphone (e.g., 24). The volume controls 38, 40 may be independently operated.

Alternatively, if during a conversation with another party through the first call connection 18 the use should wish to place a call with a second party, then the user may activate the second switch 30 to select the second call connection 20. Activating the second switch 30 causes the processor 36 to partially open the relay 34, deactivating the microphone 26 and at least one of the earphones (e.g., 24) from the first call connection 18. Activating the second switch 30 also causes the controller to activate the second multiport relay 32 to connect the microphone 26 to an outbound path of the second call connection 20 and the previously disconnected earphone 24 to an inbound port of the second call connection 20

By leaving one earphone 22 connected to the first call connection 18, the user is still able to hear anything said by the non-selected first party of the first conversation. However, by connecting the microphone 26 to the second call connection 20, the first party is not able to hear anything said to a second party through the second connection 20. By connecting the microphone 26 and other earphone 24 to the second call connection 20, the user is able to place another call and engage in a conversation with a second party.

Moreover, the user is able to independently control the volume provided from each of the parties to the earphones 22, 24. In this case, the first volume control 38 may be used to adjust a volume of any audio information from the first party and the second volume control 38 may be used to adjust the volume of the audio information from the second party.

Under the first embodiment, the segregation of sound to opposite ears is much like a normal conversation where an identity of the speaker can be associated of a direction of presentation of the information. In this case, the user may select a party to whom to direct his comments by alternately activating the first switch 28 and second switch 30.

For example, if after calling and discussing some matter with the second party, the user should wish to again converse with the first party, the user may again activate the first switch 28 to again select the first party. In this case, the processor 36 will partially deactivate the second relay 34 leaving only the inbound path from the call connection 20 connected to the earphone 24 and reconnecting the microphone 26 to the outbound path of the first call connection 18.

If, on the other hand, the user should wish to end the call with the second party after conversing with the second party, then the user may simply activate the switch 30 a second time. In this case, activating the switch 38, 40 of an already selected party functions to end the call through the respective call connection 18, 20.

In another illustrated embodiment, the processor 36 may function to maintain the presentation of audio of the selected party in a fixed location (e.g., into the right ear of the user). In this case, each time a switch 38, 40 is activated to select a party, the processor 36 may activate the switches 32, 34 to reroute the audio so that audio from the selected party is presented in the right ear and the non-selected party is moved to the left ear (or visa versa).

In another illustrated embodiment, audio from the first and second party is mixed within a mixer 42 and presented to a user through both earphones 22, 24, preferably with a volume difference that allows a user to differentiate the selected source. In this case, either the headset 16 or handset 14 may be used by a user.

Under this embodiment, the call connections 18, 20 may be connected to the volume control 38, 40 in advance of mixing. As above, the microphone 18, 26 is switched by switches 32, 34 by the processor 36 between the outbound paths of the call connections 18, 20 based upon which call is selected.

In this case, the volume controls 38, 40 are also switched. One volume control 38, 40 may be designated as the selected call volume control (e.g., selector switch 38) and the non-selected call volume control (e.g., selector switch 40). As above, a first multiport switch 32 may be associated with a first call connection 18 and a second multiport switch 34 may be associated with a second call connection 20.

In this case, each time a call is received or set up through a first call connection 18, 20, the call is routed by the respective switch 32, 34 to the selected call volume control 38. When a call is received or set up on the other call connection, the processor 36 reroutes the inbound audio of the previously selected call from the selected call volume control 38 to the non-selected call volume control 40.

A specific embodiment of method and apparatus for conferencing has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of allowing a user to simultaneously participate in two separate conversations comprising:
the user independently adjusting a volume of an audio signal for each of the two separate conversations;
presenting the adjusted volume of the audio signals from the two separate conversations to the ears of the user;
presenting a voice input from the user to a first of the two separate conversations; and
muting a voice input from the user to the second of the two separate conversations.

2. The method of claim 1 further comprising presenting an audio signal of a first of the two separate conversations to a first ear of the user and an audio signal of the second of the two separate conversations to the second ear of the user;

3. The method of claim 2 further comprising the user selecting the second conversation for presentation of voice input and muting the first conversation.

4. The method as in claim 3 wherein the step of selecting the second conversation for presentation of voice input further comprises presenting the audio signal of the first conversation to the second ear of the user and the audio signal of the second conversation to the first ear of the user.

5. The method of claim 1 further comprising mixing the adjusted volume audio signal from each of the two separate conversations.

6. An apparatus for allowing a user to simultaneously participate in two separate conversations comprising:
means provided to the user for independently adjusting a volume of an audio signal for each of the two separate conversations;
means for presenting the adjusted volume of the audio signals from the two separate conversations to the ears of the user:
means for presenting a voice input from the user to a first of the two separate conversations; and
means for muting a voice input from the user to the second of the two separate conversations.

7. The apparatus for claim 6 further comprising means for presenting an audio signal of a first of the two separate conversations to a first ear of the user and an audio signal of the second of the two separate conversations to the second ear of the user;

8. The apparatus for claim 7 further comprising means available to the user for selecting the second conversation for presentation of voice input and muting the first conversation.

9. The apparatus for in claim 8 wherein the means for selecting the second conversation for presentation of voice input further comprises means for presenting the audio signal of the first conversation to the second ear of the user and the audio signal of the second conversation to the first ear of the user.

10. The apparatus for claim 6 further comprising means for mixing the adjusted volume audio signal from each of the two separate conversations.

11. An apparatus for allowing a user to simultaneously participate in two separate conversations comprising:
first and second volume controls provided to the user that independently adjust a volume of an audio signal for each of the two separate conversations;
a speaker that presents the adjusted volume of the audio signals from the two separate conversations to the ears of the user:
a microphone that presents a voice input from the user to a first of the two separate conversations; and
a processor that mutes a voice input from the user to the second of the two separate conversations.

12. The apparatus for claim 11 wherein the speaker further comprising first and second earphones wherein the first earphone presents an audio signal of a first of the two separate conversations to a first ear of the user and the second earphone presents an audio signal of the second of the two separate conversations to the second ear of the user;

13. The apparatus for claim 12 further comprising a selector switch available to the user that selects the second conversation for presentation of voice input and muting the first conversation.

14. The apparatus for claim 11 further comprising a mixer that mixes the adjusted volume audio signal from each of the two separate conversations.

15. A method of allowing a user to simultaneously participate in two separate conversations comprising:
the user independently adjusting a relative volume of an audio signal of at least one of the two separate conversations;
mixing the adjusted volume audio signal from each of the two separate conversations;
presenting the mixed audio to the ears of the user;
presenting a voice input from the user to a selected one of the two separate conversations; and
muting a voice input from the user to a non-selected one of the two separate conversations.

16. The of claim 15 wherein the one of the two different conversations with a greater relative volume further comprises the selected conversation.

17. The of claim 15 wherein the one of the two different conversations with a greater relative volume further comprises the non-selected conversation.

18. The of claim 15 further comprising the user selecting a different conversation of the two conversations as the selected conversation.

19. A method of allowing a user to simultaneously participate in two separate conversations comprising:
presenting an audio signal of a first of the two separate conversations to a first ear of the user and an audio signal of the second of the two separate conversations to a second ear of the user;
presenting a voice input from the user to a first of the two separate conversations; and
muting a voice input from the user to a second of the two separate conversations.

20. The method as in claim 19 further comprising the user independently adjusting a volume for each of the two separate conversations.

21. The method as in claim 19 further comprising the user selecting the second conversation for presentation of voice input and muting the first conversation.

22. The method as in claim 21 wherein the step of selecting the second conversation for presentation of voice input further comprises presenting the audio signal of the first conversation to the second ear of the user and the audio signal of the second conversation to the first ear of the user.
